(19) United States
(12) Patent Application Publication
(10) Pub. No.: US 2025/0193135 A1
(43) Pub. Date: Jun. 12, 2025

(54) AGENT-BASED, CONTEXT-PROVIDING FRONT END FOR LARGE LANGUAGE MODEL CHATBOT

(71) Applicant: PLANVIEW, INC., Austin, TX (US)

(72) Inventors: Richard SONNENBLICK, Campbell, CA (US); Mik KERSTEN, Vancouver (CA); Lee REHWINKEL, Austin, TX (US); Alan MANUEL, Austin, TX (US)

(21) Appl. No.: 18/977,576

(22) Filed: Dec. 11, 2024

Related U.S. Application Data
(60) Provisional application No. 63/609,282, filed on Dec. 12, 2023.

(51) Int. Cl. H04L 51/02; G06N 20/00

(52) U.S. Cl. CPC H04L 51/02; G06N 20/00

(57) ABSTRACT

A system interposed between a user and a chatbot includes a processor with instructions to: with a conversational interface, receive a user input; with a broker agent, based on the user input and a conversation history, pass the user input to at least one assistant agent (an action agent or a data agent). If the at assistant agent is an action agent: the system determines an action consistent with the user input; and executes the action. If the assistant agent is a data agent: the system fetches data from at least one database; and, based on the user input and the fetched data, generates a reply. The broker agent, in real time, based on the user input and the reply, formulates a chatbot prompt; passes the chatbot prompt to the chatbot; receives an answer from the chatbot; and with the conversational interface, presents the answer to the user.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### CROSS-REFERENCE TO RELATED APPLICATION

This application claims the benefit of U.S. Provisional Patent Application No. 63/609,282, filed Dec. 12, 2023, now pending, which is hereby incorporated herein in its entirety by express reference thereto.

### TECHNICAL FIELD

The subject matter described herein relates to devises, systems, and methods for providing relevant business context to a large language model (LLM) chatbot. This LLM copilot has particular but not exclusive utility for extracting actionable business intelligence from local databases using a Large Language Model (LLM).

### BACKGROUND

The value received by users of enterprise software products to effect business transformation varies widely, driven by the expertise of the user and their knowledge of the processes and frameworks in which the products are intended to operate. Even experienced staff may fail to make the most of enterprise software, to obtain timely, relevant business intelligence. As a result, as many as 70% of transformation initiatives may fail to meet their business objectives. Previous solutions required expensive training and consulting services, or attempted to code the best practices into expert systems, but these were narrowly defined and lacked a general conversational capability.

Large language model (LLM) chatbots are also known in the art, and are used for a variety of personal, artistic, and business purposes. However, although an LLM may be trained on a vast amount of data, it generally lacks context for solving specific problems. Thus, the discipline of “prompt engineering” uses trained, experienced human operators to extract useful information from an LLM.

However, because the LLM doesn't “understand” data in the same way a human can, even a well-trained human may be unable to provide large enough, detailed enough, and specific enough context to the LLM to obtain actionable answers for sequences of related business questions. Furthermore, the LLM may be unable to take action on the data it is given, or even to act on certain specific instructions from a human operator.

Accordingly, a need exists for improved business decision-making tools that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is an LLM copilot system and method that allows users to ask questions about their current strategic and operational business initiatives by providing an intelligent front-end to a large language model (LLM) chatbot (e.g., by interposing between the user and the chatbot). The questions asked by the user can be specific or open-ended. The answers to these questions may be based on historical data, current data, a library of best-practices, and other sources. Into an LLM prompt (e.g., a question or command posed by a user), the LLM copilot injects data from applications running the LLM copilot, as well as benchmarks related to the data, machine learning-derived insights based on models trained with historical data, and business rules in paragraph form. Business rules may be provided by the LLM copilot and/or by the customer or other user. This aspect of the present disclosure provides more accuracy and convenience, as the end user receives higher quality responses simply by providing material that may already exist in human-readable form (e.g., policy descriptions), without the need to construct rules manually. This provides a set of instructions directing the LLM to analyze the data using the business rules to offer a set of insights and prescriptions and to answer follow-on questions. The LLM copilot disclosed herein has particular, but not exclusive, utility for extracting actionable business intelligence from local databases using a Large Language Model (LLM).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system interposed between a user and a chatbot. The system includes a processor and a computer readable medium operably coupled thereto. The computer readable medium may include a plurality of instructions stored in association therewith that are accessible to, and executable by, the processor, to perform operations which may include, in real time: with a conversational interface, receiving a user input; with a broker agent, based on the user input and a conversation history, passing the user input to at least one assistant agent, where the at least one assistant agent may include an action agent or a data agent; if the at least one assistant agent is an action agent: determining an action may include with the user input, and executing the action, or if the at least one assistant agent is a data agent: fetching data from at least one database; and based on the user input and the fetched data, generating a reply. The system also includes with the broker agent, in real time, based on the user input and the reply: formulating a chatbot prompt; passing the chatbot prompt to the chatbot; receiving an answer from the chatbot; and with the conversational interface, presenting the answer to the user. Other embodiments of this aspect include corresponding computer systems, apparatus, and computer programs recorded on one or more computer storage devices, each configured to perform the actions of the methods.

Implementations may include one or more of the following features. The system may include the chatbot. The chatbot may include a first large language model (LLM) chatbot or machine learning (ML) chatbot. The action agent, data agent, or broker agent may include or communicate with a second LLM or ML chatbot. The second LLM or ML chatbot and the first LLM or ML chatbot may be the same. The action agent may be selected from a plurality of action agents by the broker agent based on the user input; or the data agent may be selected from a plurality of data agents by the broker agent based on the user input. The conversational interface may be part of a business intelligence software application, where the at least one database may include data related to a business, and where the user input is related to the data or the business. The data agent may include a help bot, a flow metric bot, an objectives agent, a key results agent, or a roadmap agent. The at least one database may include a customer success, customer service, flow data, objectives, key results, roadmap, project portfolio, work plan, or resource allocation database. The data may include at least one of a document, application data, a knowledge graph, a tabular data frame, or a relational database. The at least one assistant agent may include a plurality of data agents, where formulating the chatbot prompt includes combining and summarizing replies from the plurality of data agents. The operations further may include, with the broker agent: summarizing the answer; and with the conversational interface, presenting the summarized answer to the user. Implementations of the described techniques may include hardware, a method or process, or computer software on a computer-accessible medium.

One general aspect includes a computer-implemented method for interposing between a user and a chatbot. The computer-implemented method includes, with a conversational interface, receiving a user input. The method also includes with a broker agent, based on the user input and a conversation history, passing the user input to at least one assistant agent, where the at least one assistant agent may include an action agent or a data agent. The method also includes, if the at least one assistant agent is an action agent: determining an action based on the user input, and executing the action. The method also includes, if the at least one assistant agent is a data agent: fetching data from at least one database; and based on the user input and the fetched data, generating a reply. The method also includes with the broker agent, in real time, based on the user input and the reply: formulating a chatbot prompt; passing the chatbot prompt to the chatbot; receiving an answer from the chatbot; and with the conversational interface, presenting the answer to the user. Other embodiments of this aspect include corresponding computer systems, apparatus, and computer programs recorded on one or more computer storage devices, each configured to perform the actions of the methods.

Implementations may include one or more of the following features. The chatbot may include a first large language model (LLM) chatbot or machine learning (ML) chatbot. The action agent, data agent, or broker agent may include or communicate with a second LLM or ML chatbot. The second LLM or ML chatbot and the first LLM or ML chatbot may be the same. The action agent may be selected from a plurality of action agents by the broker agent based on the user input; or the data agent may be selected from a plurality of data agents by the broker agent based on the user input. The at least one assistant agent may include a plurality of data agents, and formulating the chatbot prompt may include combining and summarizing replies from the plurality of data agents. The method may include, with the broker agent: summarizing the answer; and with the conversational interface, presenting the summarized answer to the user. A non-transitory computer-readable storage medium storing instructions, when executed by at least one processor of a computer system, causes the computer system to carry out the method. A computer system may include: one or more processors; and a storage medium storing instructions, which when executed by at least one processor, cause the system to implement the method. The conversational interface may be part of a business intelligence software application, where the at least one database may include data related to a business, and where the user input is related to the data or the business. The data agent may include a help bot, a flow metric bot, an objectives agent, a key results agent, or a roadmap agent. The at least one database may include a customer success, customer service, flow data, objectives, key results, roadmap, project portfolio, work plan, or resource allocation database. The data may include at least one of a document, application data, a knowledge graph, a tabular data frame, or a relational database. Implementations of the described techniques may include hardware, a method or process, or computer software on a computer-accessible medium.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the LLM copilot, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form of an example LLM copilot, in accordance with at least one embodiment of the present disclosure.

FIG. 2 is a schematic, diagrammatic representation, in block diagram form of an example LLM copilot, in accordance with at least one embodiment of the present disclosure.

FIG. 3 is a schematic, diagrammatic representation, in block diagram form of an example data agent, in accordance with at least one embodiment of the present disclosure.

FIG. 4 is a screen display of an example enterprise business intelligence application that incorporates an LLM copilot, in accordance with at least one embodiment of the present disclosure.

FIG. 5 shows a flow diagram of an example LLM copiloting method according to at least one embodiment of the present disclosure.

FIG. 6 is a schematic, diagrammatic representation, in block diagram form, of an example help bot agent, in accordance with at least one embodiment of the present disclosure.

FIG. 7 is an example screen display for a business intelligence application, in accordance with at least one embodiment of the present disclosure.

FIG. 8 is a schematic, diagrammatic representation, in block diagram form, of an example flow metric bot agent, in accordance with at least one embodiment of the present disclosure.

FIG. 9 is a schematic, diagrammatic representation, in block diagram form, of an example data flow of an LLM copilot, in accordance with at least one embodiment of the present disclosure.

FIG. 10 is a schematic diagram of a processor circuit, in accordance with at least one embodiment of the present disclosure.

### DETAILED DESCRIPTION

In accordance with at least one embodiment of the present disclosure, an LLM copilot is provided which allows users to ask questions about their current strategic and operational business initiatives by providing an intelligent front-end to a large language model (LLM) chatbot (e.g., by interposing between the user and the chatbot). Depending on the implementation, the LLM may be a remote or third-party LLM such as GPT-4, DaVinci, ChatGPT Turbo, Dolly v2, or Git Copilot, or a future-developed LLM.

The questions asked by the user can be specific (e.g., “Tell me about the Loyalty Program initiative”) or open-ended (e.g., “What should I worry about?”). The answers to these questions may be based on historical data (e.g., data from over twenty years of customer interactions, e.g., with Planview applications), current data (e.g., data in application production databases), a library of best-practices (e.g., a library developed by consulting staff, augmented by industry best-practices), and other sources (including other instances of the LLM copilot). The data used by the LLM copilot may for example include a flow metrics over time dataset, a flow distribution over time dataset, an objectives dataset, a key result dataset, a roadmaps dataset, and a roadmap milestones dataset.

Unlike existing conversational assistants, the LLM copilot of the present disclosure employs this library of best practices to deliver high-level insights and recommendations. The LLM copilot combines (i) compressed customer data from applications running the LLM copilot, as well as stratified and segmented benchmarks based on that customer data, and (ii) machine learning-derived insights based on models trained with historical customer data, into an LLM prompt (e.g., a question or command posed by a user). Business rules may be described in paragraph form, thus providing a set of instructions directing the LLM to analyze the customer data using the business rules to offer a set of insights and prescriptions and to answer follow-on questions from the user.

In an example, with the LLM copilot acting as a front end for the LLM, a human operator desires, and obtains, answers to three natural-language, natural-context questions, and may then request, and obtain, actions related to the answered questions, as shown below:
Operator: Why is one objective behind?
LLM copilot: The objective “Improve Customer Experience” is behind schedule because the associated key result “Customers Migrated to New Portal” is not progressing as expected. This is due to the related activity “Portal UI” being in the “Waiting” state, indicating possible delays or issues in completing the activity, which affects the progress of the key result and the overall objective.
Operator: Is the team overloaded by tech debt?
LLM copilot: Yes, the team is overloaded. The Flow Load (70) is 5.83 times greater than the Flow Velocity (12), which exceeds the threshold of 1.5 times. However, the percentage of tech debt in the most recent time period (Time Period 12, 2023 May) is 10%, which is not excessively high. It's important to monitor and manage the tech debt to prevent further overloading the team or negatively impacting the delivery of other work items.
Operator: Can we delay any roadmap items to help?
LLM copilot: Yes, we can delay the “Loyalty Program” card (AgilePlace Card Id 10135972982) as it has a Flow State of “New” and has not started yet. Delaying the start date of this card can help manage the team's workload. However, remember to adjust the end date accordingly to maintain the same duration between the start and end dates.
Operator: Delay it by 3 months
LLM copilot: [execute as a confirm button in the UI which triggers the API to move the AgilePlace Card dates]

```
{
  “function_call”: {
    “name”: “update_agileplace_dates”,
    “arguments”: {
      “agileplace_card_id”: 10135972982,
      “new_start_date”: “2023-11-15”,
      “new_end_date”: “2024-02-15”,
      “reason_for_date_change”: “Delaying the start date to help manage the team's workload
and reduce overload.”
    }
  }
}
```

Operator: Summarize the change in email to mik@planview.com.
LLM copilot: [execute as a mailto link on the user's laptop]

```
{
  “function_call”: {
    “name”: “send_email”,
    “arguments”: {
      “email_subject”: “Delay in Loyalty Program Roadmap Item”,
      “email_body”: “Dear Mik,\n\nWe have analyzed the team's workload and identified an
opportunity to help manage the overload by delaying the start of the ‘Loyalty Program’
roadmap item (AgilePlace Card Id 10135972982).\n\nThe original start date was 2023-08-15,
and the original end date was 2023-11-15. We have decided to delay the start date by 3
months to better manage the team's workload.\n\nThe new start date is 2023-11-15, and the
new end date is 2024-02-15. This change should help reduce the team's overload and improve
overall work delivery.\n\nPlease let us know if you have any questions or concerns regarding
this change.\n\nBest regards,\nPlanview Copilot”,
      “email_recipient_address”: “mik@planview.com”
    }
  }
}
```

In another example, in preparation for a review with the chief product officer (CPO) for a value stream, a human operator representing a value stream owner is viewing business intelligence with a business intelligence tool whose screen display shows: (1) a flow metrics widget showing flow metrics for the value stream, (2) a roadmaps widget showing a roadmap for the value stream, and (3) an objectives and key results (OKR) widget showing some OKRs. The LLM copilot disclosed herein has access to all of the data on the screen display, and can interact with the data in up to three ways: summarize (e.g., examine the data and explain what it means), interrogate (e.g., respond to a specific question about the data), or act (e.g., take action on the data as described below).
Operator: How are we doing overall on this value stream?
LLM copilot: On a per developer basis, this value stream is about as productive as others, but aligned output is starting to slip.
Flow Load has reached over 150% of Flow Velocity (throughput), which is the maximum recommended Flow Load for predictable flow.
Defect work has also exceeded the recommended levels in the last two periods, indicating a possible product quality issue.
And feature [x] is taking much longer than expected to complete. It has been replanned twice and is not predicted to finish until [x], which is over [x] days longer than the original estimate.
Operator: Which of these issues should I focus on?
LLM copilot: You already have actions in place to look at Flow Load and Defect work for this value stream, so focus on feature [x].
Operator: How important is feature [x]?
LLM copilot: Feature [x] is needed in order to complete delivery of feature [y] and feature [z], both of which are Tier 1 features on the roadmap for delivery next quarter. Feature [y] is critical to meet key objective [xx]; and feature [z] has been promised to customer [A].
Operator: What can we do to get feature [x] back on track?
LLM copilot: Features [x] and [y] are the lowest priority on the current roadmap, and can be moved into the next planning increment without significant downstream impacts. [and developers feel good about this one]
Over the last few planning periods, unplanned work (new items entering after PI planning has completed) has increased from [n] to [m]. If you can eliminate the unplanned work this period, that should give the teams the resources to complete feature [x].
Do you want me to move these two items, and then notify you whenever new unplanned work enters this value stream until further notice?
Operator: Yes, go ahead and do that.
LLM copilot: Ok, it's done.
Operator: What does the new delivery estimate look like for feature [x]?
LLM copilot: Unfortunately, I can't see the change in flow yet, but I should be able to see results within a week. Should I set a reminder to review this change next week?
Operator: Yes, do that.
LLM copilot: It's done.

To achieve these results, the LLM copilot may for example be embedded within business intelligence products (e.g., within a chat panel), and may be context-aware, through data agents that share information from charts and tables currently visible in the application user interface. The copilot may drive the application, navigating to different pages within the application based on user requests or to illustrate insights surfaced by the copilot itself.

Copilot use-cases are specific to the user and their daily activities. For any given use case, there may be a set of rules derived from relevant bodies of knowledge such as scaled agile framework (SAFe), project management body of knowledge (PMBOK), and projects in controlled environments (PRINCE). These rules can then be applied by data agents to the contextually relevant data and used by a broker agent to answer user questions such as “What should I worry about?” (WSIWA). The broker agent can then execute actions on the user's behalf (especially those actions suggested by the broker agent) and to ask for more detailed information, at which point the broker agent may provide links to navigate the application to relevant application pages.

The copilot may include the broker agent and a number of different data agents, each accessing or controlling a different type of data. The broker agent can decide which data agents to engage, can translate data agent results into plain text, and can return a summary to the chat window, or to another portion of the business intelligence application. The broker agent accesses an LLM. The data agents may also utilize LLMs, or more traditional function calls, depending on the data source.

Each data agent may for example include a data fetcher and a data analyst. Data fetchers retrieve data from the respective sources for the data agent, whereas data analyzers transform and interpret the data. Data fetchers may employ semantic search, retrieval augmented generation (RAG), LLM-built queries into a database (e.g., a SQL, NOSQL or Graph database), data frames (e.g., in Python or another language), and/or retrieval of files (e.g., comma-separated values (CSV) files, extensible markup language (XML) files, JavaScript Object Notation (JSON) files, etc.). Data analysts may employ simple functions or rules (e.g., grounded in theory, practices, or customer processes), machine learning models, and/or LLMs to analyze the fetched data.

The technology described herein can be applied to enterprise software domains where there is an intersection of software tools and codified processes for best practice. The LLM copilot offers suggestions to improve project functioning and, with the user's consent, can make the suggested changes to the enterprise application. Novel attributes of the LLM copilot include the sources of information used to inform the copilot (including e.g. internal documents detailing customer best practices, as well as guidelines issued by third-parties (SAFe, PRINCE, PMBOK), the codification of aforementioned sources into rules and policies that can be tested within business intelligence applications, a user-driven rule builder that allows customers to create their own rules that are tested by the LLM copilot, and the use of a broker agent to coalesce and prioritize multiple sources of rules and data relevant to specific user use cases.

The present disclosure aids substantially in generating and interpreting business intelligence, situational and environmental realities, by improving a user's ability to retrieve, interpret, and act on available data. Implemented on a processor in communication with a one or more databases, the LLM copilot disclosed herein provides practical, actionable information, and can itself act on the information with approval from a user. This augmented business decision-making capability transforms a slow, subjective, error-prone process into one that is robust and repeatable, without the normally routine need to rely on subjective judgments of human managers. This unconventional approach improves the functioning of both the LLM and the computer running the LLM, by allowing them to generate relevant, accurate, actionable business intelligence, in immediately usable forms, from data sources that would not normally be accessible to the LLM.

The LLM copilot may be implemented as a process at least partially viewable on a display, and operated by a control process executing on a processor that accepts user inputs from a keyboard, mouse, or touchscreen interface, and that is in communication with one or more databases. The LLM copilot may also proactively notify the user. For example, a user might say “Send me a summary of this team's status at the end of the week” and the user may then receive an email summary at the appropriate time, without having to further interact with the LLM copilot. In that regard, the control process performs certain specific operations in response to different inputs or selections made at different times. Some outputs of the LLM copilot may be printed, shown on a display, read aloud, or otherwise communicated to a human operator. The same or other outputs of the LLM copilot may be stored in a memory or communicated to the large language model chatbot. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the LLM copilot. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

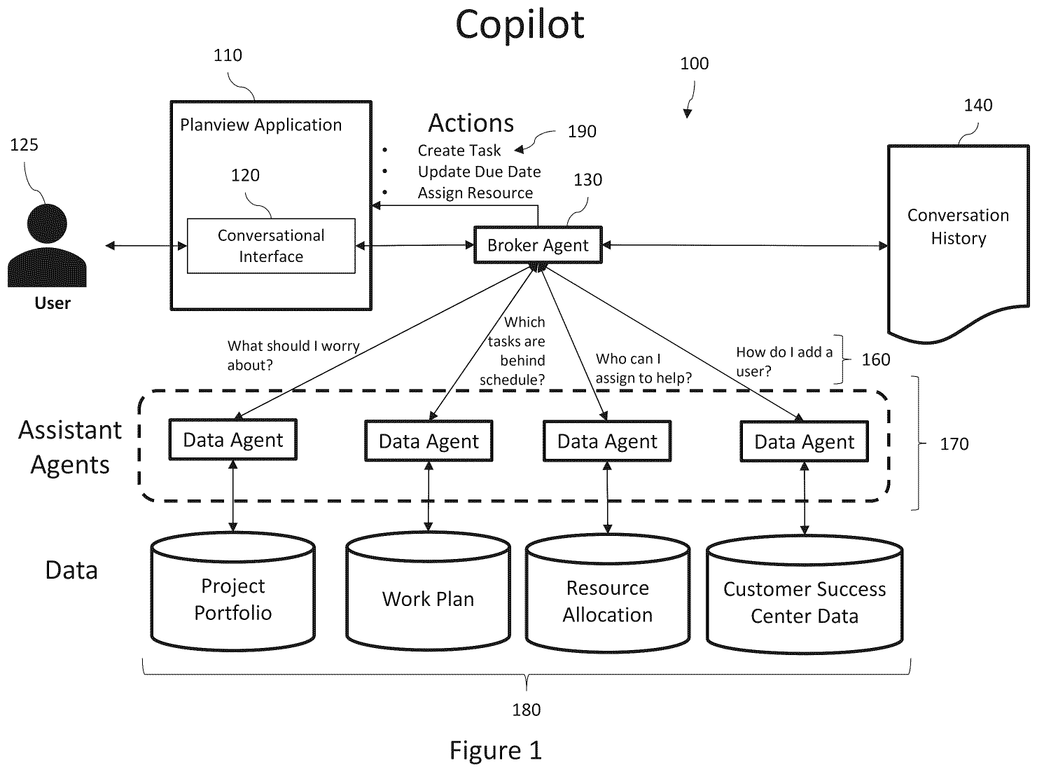

FIG. 1 is a schematic, diagrammatic representation, in block diagram form of an example LLM copilot 100, in accordance with at least one embodiment of the present disclosure. In the example shown in FIG. 1, the LLM copilot 100 includes a business intelligence application 110 (e.g., an enterprise-level application), a broker agent 130 and at least one data agent 170. The broker agent 130 decides which data agents 170 to engage, translates data agent results into plain text, and returns a summary to the application 110.

Via a conversational interface 120 (e.g., a chat window) of the application 110, the broker agent 130 converses with a user 125 and calls upon one or more data agents or assistant agents 170 to help answer the user's questions.

Inputs to the broker agent, for example, include user questions, a conversation history 140, and a list of available assistants 170. Outputs of the broker agent generally include answers to the user's questions. In the example shown in FIG. 1, the broker agent is or includes an LLM. Furthermore, the data agents may be, include, or utilize LLMs, expert systems, or more traditional function calls, depending on the type of database 180 the agent employs as its data source. Depending on the type and content of the user's question, the broker agent 130 decides which data agent or agents 170 to engage.

Each data agent, assistant, or assistant agent 170, once engaged, returns a data frame that can be used by an expert (e.g., the LLM) to answer a question. In an example, a data agent 170 may use an economic model to filter a large dataset to only the rows and/or columns needed for a more costly model (e.g., the LLM) to analyze and answer the question. In an example, the inputs to the data agent 170 include a question 160 (e.g., the user's question), and a table name (e.g., the name of a data table located in the agent's respective database 180), and the outputs of the data agent 170 include a data frame with a LLM-readable schema (e.g., SQL or Cypher or JSON, as appropriate) to enable interpretation of the data frame.

In some embodiments, each data agent 170 can only query one data table at a time. In other implementations, a data agent 170 may be or include a retrieval augmented generation (RAG) agent that is configured to search a knowledge base to answer a question. In such cases, the inputs to the RAG agent may include a question (e.g., the user's question) and a context (e.g., which application 110 is being used by the user 125, the conversation history 140, etc.), and outputs from the RAG agent include a search result, which may for example be or include a generative response (e.g., an answer to the question) rather than a raw search result.

Thus, the broker agent 130 decides which data agents 170 to engage, translates data agent outputs into plain text, and returns a summary to the main application 110. Depending on the type of question asked by the user, the broker agent 130 is also capable of generating actions 190, such as creating a new task, updating the due date for a task, assigning an idle resource to a task, etc.

Data Agents may utilize LLMs, or more traditional function calls, depending on data source.

Block diagrams are provided herein for exemplary purposes; a person of ordinary skill in the art will recognize myriad variations that nonetheless fall within the scope of the present disclosure. For example, any of the steps or blocks described herein may optionally include an output to a user of information relevant to the step or block, and may thus represent an improvement in the user interface over existing art by providing information not otherwise available. Similarly, the LLM copilot as a whole represents an improvement in business enterprise software user interfaces, by providing a natural-language, natural-context interface that lets a user communicate with an LLM as though the LLM knew and understood detailed information about the user's business.

Block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Before continuing, it should be noted that the examples described above (and herein, generally) are provided for purposes of illustration, and are not intended to be limiting. Other devices and/or device configurations may be utilized to carry out the operations described herein.

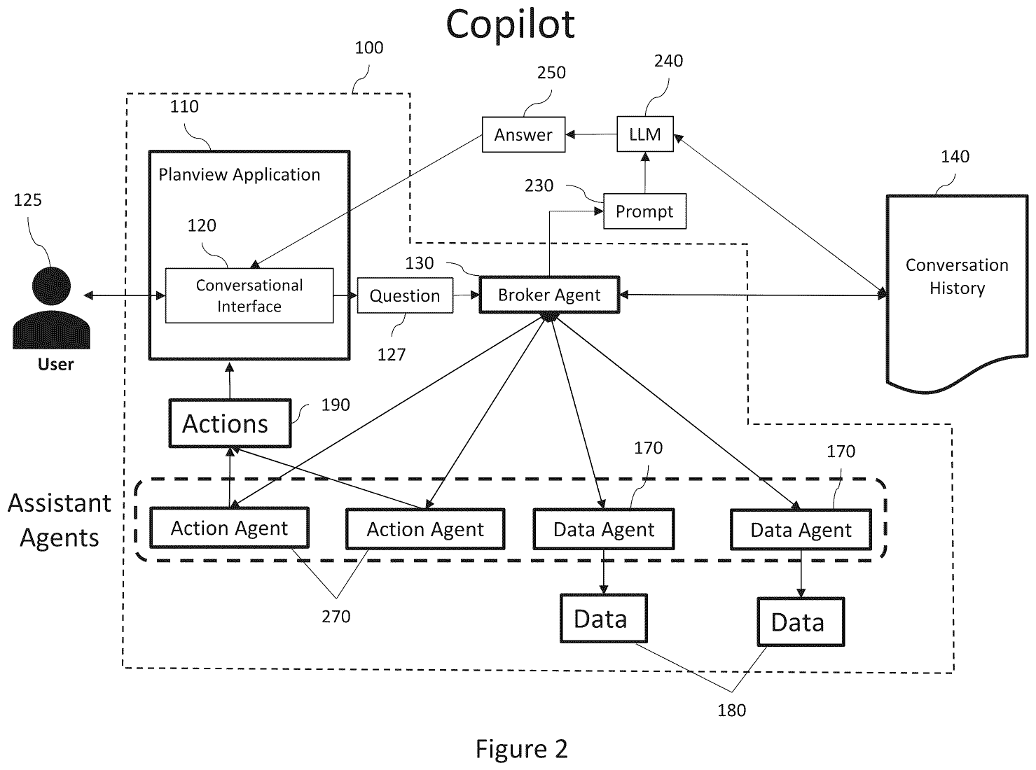

FIG. 2 is a schematic, diagrammatic representation, in block diagram form of an example LLM copilot 100, in accordance with at least one embodiment of the present disclosure. This embodiment shows the business intelligence application 110, conversational interface 120, user 125, broker agent 130, conversation history 140, data agents 170, and databases 180. Also shown are action agents 270. Unlike the data agents 170, the action agents 270, though they may be structurally similar to data agents 170, instead return an action 190 to control the application 110, rather than an answer 250 to be displayed in the conversational interface 120.

Furthermore, in the example shown in FIG. 2, the LLM 240 is separate from the LLM copilot 100, and may for example be a remote or third-party LLM such as GPT-4, DaVinci, ChatGPT Turbo, Dolly v2, or Git Copilot, or other LLM available at any time to those of ordinary skill in the art. In this example, the LLM copilot 100 does not produce an answer 250 to the user's question 127. Rather, the broker agent 130 produces a prompt 230 that, while it may include the user's question, provides additional instructions and/or context for the LLM 240, such that the answer 250 produced by the LLM 240 and returned to the conversational interface 120 is informed by data 180 that is specific to the user's business, and tailored to the needs of the user's business.

Thus, the LLM copilot 100 provides an intelligent front end to the LLM 240, which both increases the capability of the LLM 240 and also constrains its actions and responses of the LLM 240 such that they are more likely to be useful to the user 125.

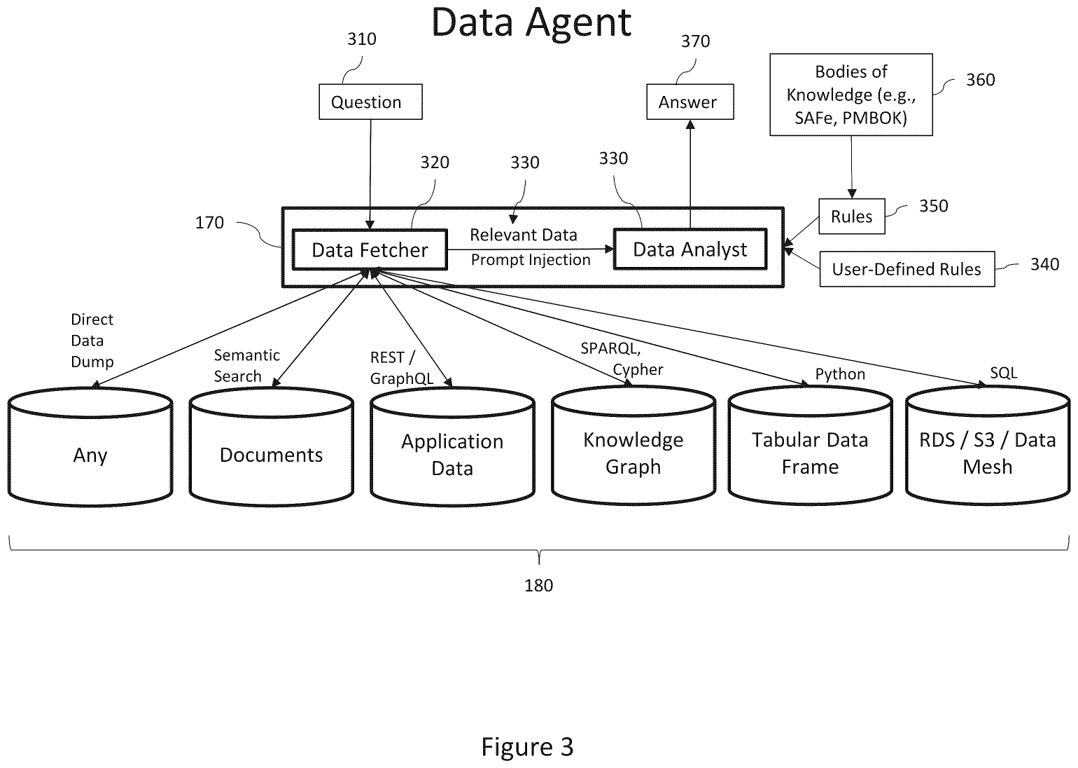

FIG. 3 is a schematic, diagrammatic representation, in block diagram form of an example data agent 170, in accordance with at least one embodiment of the present disclosure. In the example shown in FIG. 3, the data agent 170 includes a data fetcher 320 and a data analyst 330. The data fetcher 320 retrieves data from one or more databases 180, and may employ semantic search (RAG), LLM-built queries submitted into a DB (e.g., an SQL, NOSQL, or Graph database), dataframes (e.g., in Python or another language), and/or retrieval of data files (including but not limited to comma-separated values (CSV), extensible markup language (XML), or Javascript Object Notation (JSON) files).

The data analyzer or data analyst 330 is configured to transform and interpret the data 330 retrieved by the data fetcher 320. Depending on the implementation, the data analyst 330 may employ simple functions/rules (e.g., grounded in theory, practices, or customer processes), machine learning models, and/or LLMs (whether internal, external, third-party, etc.) to analyze the fetched data and produce an answer 370. This answer 370 may be the answer 250 that gets passed back to the user 125, or may be an intermediate answer that gets passed back to the broker agent 130 to be incorporated into an LLM prompt 230 (see FIG. 2).

The rules employed by the data agent 170 may include user-defined rules 340 and/or rules 350 derived from industry bodies of knowledge 360 such as scaled agile framework (SAFe), project management body of knowledge (PMBOK), etc.

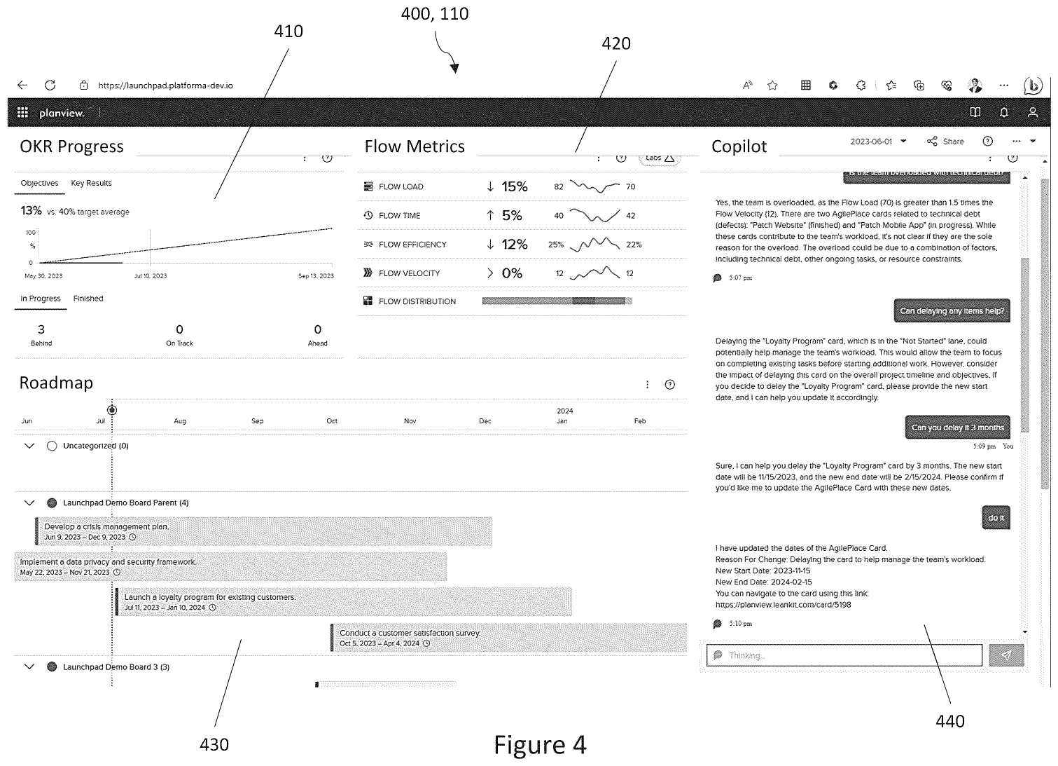

FIG. 4 is a screen display 400 of an example enterprise business intelligence application 110 that incorporates an LLM copilot 100, in accordance with at least one embodiment of the present disclosure. In the example shown in FIG. 4, the screen display 400 includes an objectives and key results (OKR) panel 410, a flow metrics panel 420, a roadmap panel 430, and an LLM copilot chatbot panel 440.

The OKR panel 410 may for example be or include a simple progress indicator or graph, or may include detailed information (whether text or graphical) concerning objectives and key results, such as the number of objectives or key results that are currently on schedule, the number that are currently ahead of schedule, and the number that are currently behind schedule.

For purposes of the present disclosure, the term “flow” is synonymous with “work in progress.” The flow metrics panel 420 may, for example, include text or graphical representations of flow-related variables over time. Such variables may include, but are not limited to: flow load (e.g., the percentage of time one or more teams are busy with work in progress), flow time (e.g., the time required to complete work in progress), flow efficiency (e.g., the time efficiency with which work in progress is being completed), and/or flow distribution (e.g., how evenly the work in progress is distributed over time).

The roadmap panel 430 may for example include expandable Gantt charts or other chronological representations of one or more projects, tasks, objectives, key results, etc.

Depending on the implementation, clicking on the OKR progress panel 410, flow metrics panel 420, or roadmap panel 430 may bring up a more detailed view (e.g., in a pop-up window). Each of the OKR progress panel 410, flow metrics panel 420, and roadmap panel 430 may be constructed from, or may be used to construct, one or more comma-delimited tables that can be passed to the broker agent 130 by a respective data agent 170 (see FIG. 1).

The LLM copilot chat window 440 may for example provide a text interface for communicating with the LLM, using the LLM copilot as a front end. Thus, the LLM copilot chat window 440 may include questions asked by the user, and answers given by the LLM, with the help of expanded prompts supplied to the LLM by the LLM copilot. In an example, the user can type an arbitrary number of questions into the LLM copilot chat window 440, and both the LLM and the LLM copilot will remember the conversation history. In the non-limiting example of FIG. 4, answers displayed in the LLM copilot chat window 440 may for example be limited to answers regarding the data shown in the OKR progress panel 410, flow metrics panel 420, and roadmap panel 430.

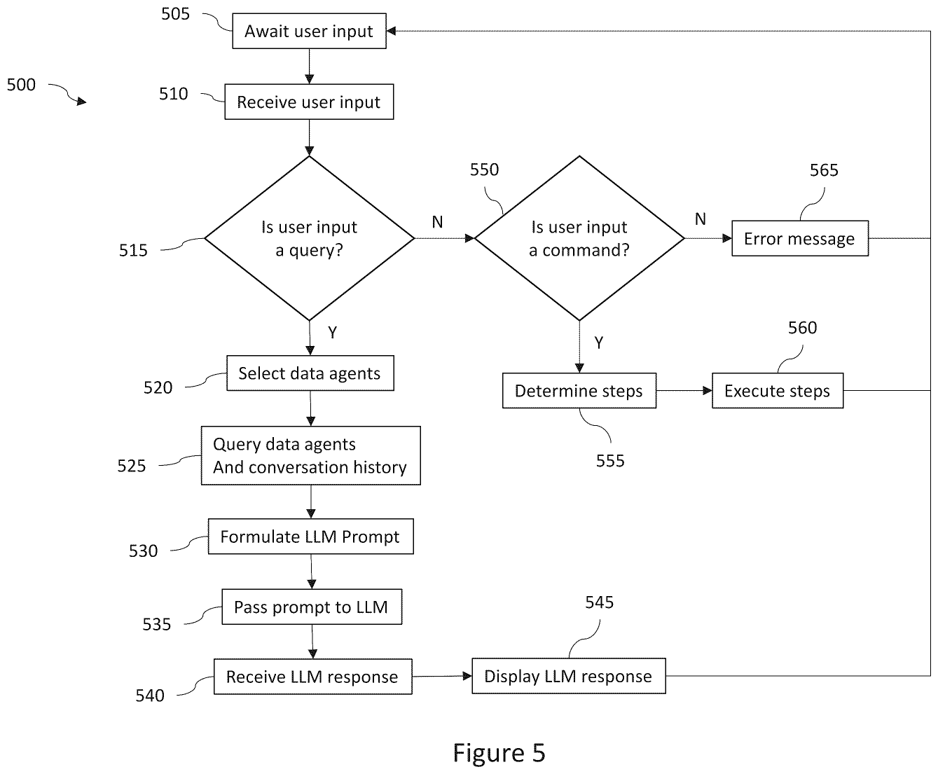

FIG. 5 shows a flow diagram of an example LLM copiloting method 500, in accordance with at least one embodiment of the present disclosure. It is understood that the steps of method 500 may be performed in a different order than shown in FIG. 5, additional steps can be provided before, during, and after the steps, and/or some of the steps described can be replaced or eliminated in other embodiments. One or more of steps of the method 500 can be carried by one or more devices and/or systems described herein, such as components of the system 100 and/or processor circuit 1050.

In step 505, the method 500 includes waiting for a user input. Execution then proceeds to step 510 once the user input occurs.

In step 510, the method 500 includes receiving the user input. Execution then proceeds to step 515.

In step 515, the method 500 includes determining whether the user input is a query or other question for the LLM copilot. If yes, execution then proceeds to step 520. If no, execution proceeds to step 550.

In step 520, the method 500 includes selecting data agent(s) that are relevant to the user's question. Execution then proceeds to step 525.

In step 525, the method 500 includes querying the data agents and the conversation history in order to develop a context for the user's question. Execution then proceeds to step 530.

In step 530, the method 500 includes formulating a prompt for the LLM that includes the context developed in step 525.

One example prompt, including the context, is:

You are a helpful chatbot that answers questions about Product X.

Use the search results in the sections labeled—SEARCH RESULT N—as context for your answer.

Be helpful in your response.

Provide the hyperlink when referencing a search result.

If you don't know the answer, don't try to make up an answer.

### —Search Result 1—

Title: Get Started with Product X
Description: \Do you need a helping hand to get started with Product X? This video may help.
Hyperlink: https://success.planview.com/X_Y/X_Fundamentals/Get_started

### —Search Result 2—

Title: Get Started with Product X
Description: invitation email please ask the person in your organization to re-invite you.
Hyperlink: https://success.planview.com/X_Y/X_Fundamentals/Get_started2

Another example prompt, including different context, is:

Answer the following questions and obey the following commands as best you can.

You have access to the following tools:

Help_Bot: Useful when asking questions about Company X products. You should ask targeted questions.

Flow_Metric_Bot: Useful for when you need to answer questions about Flow Metric data and trends.

Response_To_Human: When you need to respond to the human you are talking to.

You will receive a message from the human, then you should start a loop and do one of two things:

```
  Option 1: You use a tool to answer the question.
  For this, you should response using the following JSON format:
  {
    “Thought”: You should always think about what to do,
    “Action”: The action to take, should be one of [Help_Bot, Flow_Metric_Bot],
    “Action_Input”: the input to the action, to be sent to the tool
  }
  Option 2: You respond to the human.
  For this, you should response using the following JSON format:
  {
    “Action”: “Response_To_Human”,
    “Action_Input”: Your response to the human, summarizing what you did and
what you learned.
  }
```

In still another example, when a user asks, “How do I reset my password?”, the prompt may be:

```
  {
  “Thought”: “This question is related to a product feature, most likely in Product
X. I should use the Help_Bot to get accurate information.”,
  “Action”: “Help_Bot”,
  “Action Input”: “How can a user reset their password in Product X?”
  }
```

In still another example, when a user asks a question related to flow, the LLM copilot may poll a flow agent, and incorporate its outputs into a prompt such as:

You are a Flow Framework expert that interprets Flow Metric data and answers questions about key trends.

Use the comma delimited data below as context for your answer.

Explain how any referenced trends are related to business outcomes.

Provide numeric examples that support your answer.

If you don't know your answer, don't try to make up an answer.
Dataset: Flow Metrics by Month

### Description:

Each row represents a Month and Year.

Flow Load measures the number of Flow Items being actively worked on.

Flow Load is also referred to as WIP or Work In Progress.

Monitoring Flow Load helps determine if a team is overloaded or has spare work capacity.

A large Flow Load could indicate a team is overloaded and will have difficulty delivering their work on time.

A small Flow Load could indicate a team does not have enough work.

Flow Velocity measures the number of Flow Items that were completed over a given period of time.

Monitoring Flow Velocity helps teams improve their estimates for how much work they can deliver during a period of time.

Increasing Flow Velocity is a positive trend as it indicates a team is delivering more work.

Consistent Flow Velocity is positive because it means a team can predict the amount of work they can deliver.

Flow Time is the elapsed time it takes from when work enters the Value Stream to when it is considered done.

Flow Time includes both Active and Waiting work states.

Monitoring Flow Time helps teams predict how long it will take to complete work.

Decreasing Flow Time is a positive trend as it indicates a team is taking less time to delivery work.

Consistent Flow Time is positive because it means a team can predict the amount of time needed to deliver work.

Flow Efficiency is the percentage of time where work is in an Active state versus a Waiting state.

Monitoring Flow Efficiency helps to identify bottlenecks that slow down work delivery.

A large Flow Efficiency is positive as it indicates fewer bottlenecks.

### Time Period, Year, Month, Flow Load, Flow Velocity, Flow Time, Flow Efficiency

1, 2022, Dec., 82, 12, 40, 25%
2, 2023, Jan., 76, 11, 43, 20%
3, 2023, Feb., 66, 15, 40, 32%
4, 2023, Mar., 72, 13, 38, 34%
5, 2023, Apr., 60, 16, 31, 26%
6, 2023, May, 63, 19, 26, 40%
7, 2023, Jun., 55, 18, 32, 35%
8, 2023, Jul., 49, 16, 27, 32%
9, 2023, Aug., 65, 22, 25, 42%
10, 2023, Sep., 68, 18, 30, 33%
11, 2023, Oct., 72, 15, 35, 30%
12, 2023, Nov., 70, 12, 42, 22%

Question: Is there anything I should be worried about?

Share your step by step thought process.

In still another example related to flow, the LLM copilot may poll a more complex flow agent (which in some cases may itself be an LLM) whose outputs can be incorporated into a more complex prompt:

You are a helpful product manager that answers questions for a business executive.

Your job is summarize your analysis below to answer the question at the end.

Your response should limit the use of technical jargon.

Use bullet points when appropriate.

Based on the provided data, we can analyze the following trends and their impacts on the business outcomes:

### Flow Load (WIP):

The Flow Load, or work in progress, shows a general decreasing trend from 82 in December 2022 to 70 in November 2023. This indicates that the team has been able to reduce the number of work items being actively worked on. This could mean the team is managing their workload more effectively, reducing the risk of being overloaded. This is a positive trend as it allows the team to focus on the most important tasks and avoid multitasking and context switching.

### Flow Velocity:

There is a general increase in Flow Velocity from 12 in December 2022 to 22 in August 2023, and then a decrease to 12 in November 2023. This indicates the team has been able to increase their output for a while but then the velocity decreased. The variability in this metric might suggest that the team's capacity to deliver work is not consistent. This inconsistency can make it challenging for stakeholders to predict delivery timelines and could impact business planning.

### Flow Time:

The Flow Time generally decreased from 40 days in December 2022 to 25 days in August 2023, and then increased to 42 days in November 2023. This decreasing trend followed by an increase suggests that the team was becoming more efficient in delivering work but then faced some challenges. This increase in flow time can negatively impact business outcomes if work items are taking longer to complete than estimated, causing possible delays in product delivery or release cycles.

### Flow Efficiency:

The Flow Efficiency shows a general increasing trend from 25% in December 2022 to 42% in August 2023, and then a decrease to 22% in November 2023. An increasing trend in flow efficiency suggests that the team was becoming more efficient, spending less time in a waiting state and more time actively working. However, the decrease at the end might be a sign of increasing bottlenecks. This could be due to a variety of reasons, such as increased complexity of work items, lack of resources, or dependencies on other teams or systems. This could have a negative impact on business outcomes as it could delay the delivery of work items.

In conclusion, the data suggests some improvements in managing workloads and efficiency for most of 2023, with a decrease in performance towards the end of the year. The decrease in flow velocity and efficiency and the increase in flow time and load in the later months might be a cause for concern. These trends could affect the team's ability to predictably deliver work and could have a potential impact on the overall business outcomes.

As a next step, it would be helpful to investigate the causes of these trends and consider any changes in the team or organization that might have affected the team's performance. By understanding the root causes, the team can take steps to improve their flow metrics and ultimately their delivery of work.

Question: Is there anything I should be worried about?

In still another example, the LLM copilot may poll, and assemble data from, multiple agents to produce an even more complex prompt, such as:

You are Product X Copilot.

Your job is to interpret Product X datasets and use them to answer the user's questions and suggest Actions.

Use the comma delimited datasets below as context for your answer.

Only answer questions related to the datasets below.

Each dataset includes Actions you may suggest.

When suggesting an Action, ask the user if they would like to perform the Action and provide the Action Name in the following format: [[Action Name]]

Explain how any data or referenced trends are related to business outcomes.

Provide numeric examples that support your answer.

Your answer may refer to the conversation history.

If you need more information from the user, ask for it.

If you don't know the answer, don't try to make up an answer.

Today's date is 2023 Jun. 20.
Dataset: Flow Metrics Over Time

### Description:

Each row represents a Time Period.

Each Time Period occurs in order, where the highest value is the most recent.

Flow Load measures the number of Flow Items being actively worked on.

Flow Load is also referred to as WIP or Work In Progress.

Monitoring Flow Load helps determine if a team is overloaded or has spare work capacity.

A large Flow Load could indicate a team is overloaded and will have difficulty delivering their work on time.

A small Flow Load could indicate a team does not have enough work.

Flow Velocity measures the number of Flow Items that were completed over a given period of time.

Monitoring Flow Velocity helps teams improve their estimates for how much work they can deliver during a period of time.

Increasing Flow Velocity is a positive trend as it indicates a team is delivering more work.

Consistent Flow Velocity is positive because it means a team can predict the amount of work they can deliver.

Flow Time is the elapsed time it takes from when work enters the Value Stream to when it is considered done.

Flow Time includes both Active and Waiting work states.

Monitoring Flow Time helps teams predict how long it will take to complete work.

Decreasing Flow Time is a positive trend as it indicates a team is taking less time to delivery work.

Consistent Flow Time is positive because it means a team can predict the amount of time needed to deliver work.

Flow Efficiency is the percentage of time where work is in an Active state versus a Waiting state.

Monitoring Flow Efficiency helps to identify bottlenecks that slow down work delivery.

A large Flow Efficiency is positive as it indicates fewer bottlenecks.

In order to maintain predictable flow, the Flow Load should not exceed 1.5 times Flow Velocity.

### Time Period, Year, Month, Flow Load, Flow Velocity, Flow Time, Flow Efficiency

1, 2022, Jun., 82, 12, 40, 25%
2, 2022, Jul., 76, 11, 43, 20%
3, 2022, Aug., 66, 15, 40, 32%
4, 2022, Sep., 72, 13, 38, 34%
5, 2022, Oct., 60, 16, 31, 26%
6, 2022, Nov., 63, 19, 26, 40%
7, 2022, Dec., 55, 18, 32, 35%
8, 2023, Jan., 49, 16, 27, 32%
9, 2023, Feb., 65, 22, 25, 42%
10, 2023, Mar., 68, 18, 30, 33%
11, 2023, Apr., 72, 15, 35, 30%
12, 2023, May, 70, 12, 42, 22%

### Actions You May Suggest:

Action Name, Description
Place Load Limit, Place an maximum limit on the number of Flow Items that be actively worked on.
Schedule Meeting, Schedule an Outlook meeting.
Dataset: Flow Item Distribution Over Time

### Description:

Each row represents a Time Period.

Each Time Period occurs in order, where the highest value is the most recent.

This dataset provides the Flow Distribution, which is the percent of Flow Load associated with each of the 4 Flow Item Types (Feature, Defect, Risk, Debt).

Monitoring Flow Distribution helps teams understand what types of work are being prioritized.

The Flow Distribution during a Time Period should sum to 100%.

Features represent new business value created. They are often tied to new functionality or capabilities of a product or service and directly contribute to a product's competitive differentiation.

Defects represent quality issues that need to be resolved. They refer to parts of the product that are not working as intended and need to be fixed.

Risks represent compliance, security, privacy, and other forms of risk-related work. This category can include tasks like security updates and technical debt reduction.

Debt represents work spent on reducing the “technical debt”. This reflects the implied cost of rework caused by choosing the quick, yet suboptimal, solution now versus using a better approach that would take longer.

Products have target Flow Distribution depending on their lifecycle stage.
Stage 1 Incubation: 80% Feature, 10% Defect, 10% Risk, 0% Debt
Stage 2 Introduction: 55% Feature, 20% Defect, 10% Risk, 15% Debt
Stage 3 Growth: 40% Feature, 20% Defect, 20% Risk, 20% Debt
Stage 4 Maturity: 30% Feature, 30% Defect, 20% Risk, 20% Debt
Stage 5 Decline: 10% Feature, 60% Defect, 10% Risk, 10% Debt

### Time Period, Year, Month, Feature Percent, Defect Percent, Risk Percent, Debt Percent

1, 2022, Jun., 80%, 19%, 1%, 0%
2, 2022, Jul., 85%, 13%, 2%, 0%
3, 2022, Aug., 82%, 12%, 1%, 5%
4, 2022, Sep., 75%, 12%, 5%, 8%
5, 2022, Oct., 70%, 19%, 3%, 8%
6, 2022, Nov., 71%, 8%, 10%, 11%
7, 2022, Dec., 54%, 28%, 8%, 10%
8, 2023, Jan., 52%, 32%, 4%, 12%
9, 2023, Feb., 43%, 40%, 5%, 12%
10, 2023, Mar., 48%, 32%, 6%, 14%
11, 2023, Apr., 45%, 36%, 7%, 12%
12, 2023, May, 40%, 40%, 10%, 10%

### Actions You May Suggest:

Action Name, Description
Schedule Meeting, Schedule an Outlook meeting.
Dataset: Objectives

### Description:

Each row represents an Objective.

Objectives are the first part of Objectives and Key Results (OKRs).

Objectives establish accountability by keeping teams focused on outcomes rather than deliverables.

The following describes each field in the Objectives dataset:
Objective Name: The name of the Objective.
Progress: The objectives percent progress to completion as calculated by the Key Result metrics.
Board: The AgilePlace board the objective is attached to.
Level: The level of the organization the objective is attached to.

The following are the ordered levels associated with this organization. The lower the number, the higher the level in the organization.
Level 1: Delivery Group
Level 2: Value Stream
Level 3: Team
Owner: The person who oversees that the Objective is completed by the Target Date.
Start Date: When the Objective began.
Target Date: When the Objective should be completed by.
Status: The status as determined by its progress to completion and the amount of time remaining until the target date.

The following are the Statuses and their interpretation:
Finished: The Objective is complete.
Ahead: The Objective is ahead of its target completion date.
On Target: The Objective is expected to be completed near its target completion date.
Below: The Objective is not expected to be complete by its target completion date.
Not Started: The Objective has not started.

### Objective Name, Progress, Board, Level, Owner, Start Date, Target Date, Status

Adopt Data Science, 66%, Data Science Program, Team, Joe Smith, Sep. 17, 2022, Oct. 22, 2023, Ahead
Patch Security Holes, 75%, IT Security, Team, Sally Brown, Jan. 1, 2023, 7/1/2023, Below
Customer Self-Serve, 0%, Platform, Portfolio, Paul Green, Jul. 2, 2022, Oct. 1, 2023, Not Started

### Actions You May Suggest:

Action Name, Description
Go to Objective, Provide a link to an Objective for more details.
Change Objective Target Date, Increase or Decrease the Objective Target Date.
Schedule Meeting, Schedule an Outlook meeting.
Dataset: Key Results

### Description:

Each row represents a Key Result.

Key Results are the second part of Objectives and Key Results (OKRs).

Key Results capture metrics and track progress toward completing an Objective.

The following describes each field in the Key Results dataset:
Key Result Name: The name of the Key Result.
Objective Name: The name of the objective associated with the Key Result. An Objective can have more than one Key Result associated with it.
Start Value: The starting value of key result metric.
Target Value: The target value of the key result metric.
Latest Value: The current value of the key result metric.
Progress: The percent of progress towards completing the key result target value metric.
Owner: The person who is responsible for the Key Result.
Start Date: The date when the key result metric started.
Target Date: The date when the key result metric should be completed.
Activities Not Started: The AgilePlace cards associated with the Key Result that have a Not Yet Started status.
Activities Started: The AgilePlace cards associated with the Key Result that have a Started status.
Activities Finished: The AgilePlace cards associated with the Key Result that have a Finished status.
Status: The Health of the Key Result as determined by its progress to completion.

The following are the Statuses and their interpretation:
Finished: The Key Result is complete.
Ahead: The Key Result is ahead of its target completion date.
On Target: The Key Result is expected to be completed near its target completion date.
Below: The Key Result is not expected to be complete by its target completion date.
Not Started: The Key Result has not started.

### Key Result Name, Objective Name, Start Value, Target Value, Latest Value, Progress, Owner, Start Date, Target Date, Activities Not Started, Activities Started, Activities Finished, Status

Data Science Widgets, Adopt Data Science, 0, 3, 2, 66%, Bob Jones, Sep. 17, 2022, Oct. 22, 2023, 1, 2, 10, Ahead
Security Hole Patches, Patch Security Holes, 0, 20, 15, 75%, Sarah Conner, Jan. 1, 2023, Jul. 1, 2023, 5, 3, 13, Below
Products Supporting Data Load, Customer Self-Serve, 0, 5, 0, 0%, Jill Strong, Jul. 2, 2022, Oct. 1, 2023, 10, 0, 0, Not Started

Actions you may suggest:
Action Name, Description
Go to Key Result, Provide a link to a Key Result for more details.
Change Key Result Target Date, Increase or Decrease the Key Result Target Date. Schedule Meeting, Schedule an Outlook meeting.
Dataset: Roadmaps

### Description:

The Roadmaps dataset maps Activities into a timeline for achieving a desired goal.

Each Roadmap exists to achieve a goal.

Each Roadmap consists of one or many AgilePlace Cards that represent the Activities needed achieve the Roadmap's goal.

Each Activity has a targeted start and end date.

Each row in the dataset represents an Activity.

A Roadmap's goal is achieved when all associated Activities have been Completed.

The following describes each field in the Roadmaps dataset:
Roadmap Name: The name of the Roadmap.
Activity Name: The name of the Activity.
Activity Status: The status of the Activity.
Activity Start Date: The date the activity is expected to start.
Activity End Date: The date the activity is expected to be completed.

### Roadmap Name, Activity Name, Activity Status, Activity Start Date, Activity End Date

Mobile App, Backend Dev, In Progress, 2023-01-01, 2023-07-01
Mobile App, Front End UI, Not Started, 2023-06-01, 2023-08-01
Website Branding, Update Logo, In Progress, 2023-01-01, 2023-07-01

Actions you may suggest:
Action Name, Description
Go to Roadmap, Provide a link to a Roadmap for more details.
Change Activity End Date, Increase or Decrease an Activity End Date.
Schedule Meeting, Schedule an Outlook meeting.
Dataset: Roadmap Milestones

### Description:

Milestones are critical markers in a Roadmap, which help ensure a Roadmap stays on track to meet its Goal.

Each Milestone has a target date in which they are expected to be completed by.

The following describes each field in the Roadmap Milestones dataset:
Roadmap Name: The name of the Roadmap.
Milestone Name: The name of the Milestone.
Milestone Date: The date the Milestone is expected to occur.

### Roadmap Name, Milestone Name, Milestone Date

Mobile App, MVP Demo, 2023 May 16
Mobile App, Customer Conference, 2023 Jul. 1, Website Branding, Go Live, 2023-08-01

Actions you may suggest:
Action Name, Description
Go to Milestone, Provide a link to a Milestone for more details.
Change Milestone Date, Increase or Decrease an Milestone Date.
Schedule Meeting, Schedule an Outlook meeting.

In some cases, the prompt includes the user's question itself. In other cases, it does not. In this way, the copiloting method 500 provides a front-end interface to the LLM that both informs and constrains its actions, such that its outputs are useful and relevant to the topic for which the copilot was trained (e.g., relevant to controlling the inputs to, and interpreting the outputs of, an enterprise business analytics package called Product X).

Execution then proceeds to step 535.

In step 535, the method 500 includes passing the prompt to the LLM. Execution then proceeds to step 540.

In step 540, the method 500 includes receiving a response from the LLM. This response may be subject to further editing or alteration before displaying to the user (e.g., restricting the display of aspects of the content, etc.). In an example, the response could be processed by another LLM to create a summary or to prioritize (and report on) the relative importance of multiple LLM responses. Execution then proceeds to step 545.

In step 545, the method 500 includes displaying the LLM response to the user (e.g., on a display). In some embodiments, the LLM response may be stored in a memory, read aloud, printed on a printer, etc. Execution then returns to step 505.

In step 550, the method 500 includes determining whether the user input is a command. Example commands include creating a task, updating a due date, assigning or reassigning a resource, etc., or combinations thereof. If yes, execution proceeds to step 555. If no, execution proceeds to step 565.

In step 555, the method 500 includes determining the steps, substeps, or tasks required to execute the command. These steps, substeps, or tasks may for example require API calls and/or simulated keyboard or mouse inputs into the business intelligence or decision-making software application in order to accomplish the desired creation, update, assignment, etc. Execution then proceeds to step 560.

In step 560, the method 500 includes executing the steps, substeps, or tasks identified in step 555, including reporting to the user either the completion of the command or completion of the individual the steps, substeps, or tasks. Execution then returns to step 505.

In step 565, the method 500 includes informing the user that the user input was not understood. Execution then returns to step 505.

Flow diagrams are provided herein for exemplary purposes; a person of ordinary skill in the art will recognize myriad variations that nonetheless fall within the scope of the present disclosure. The logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, when the user types a question or command, the system should generally respond within less than one second to avoid a user impression of lagged or sluggish response, and “real-time” should be understood to mean processing within this time frame.

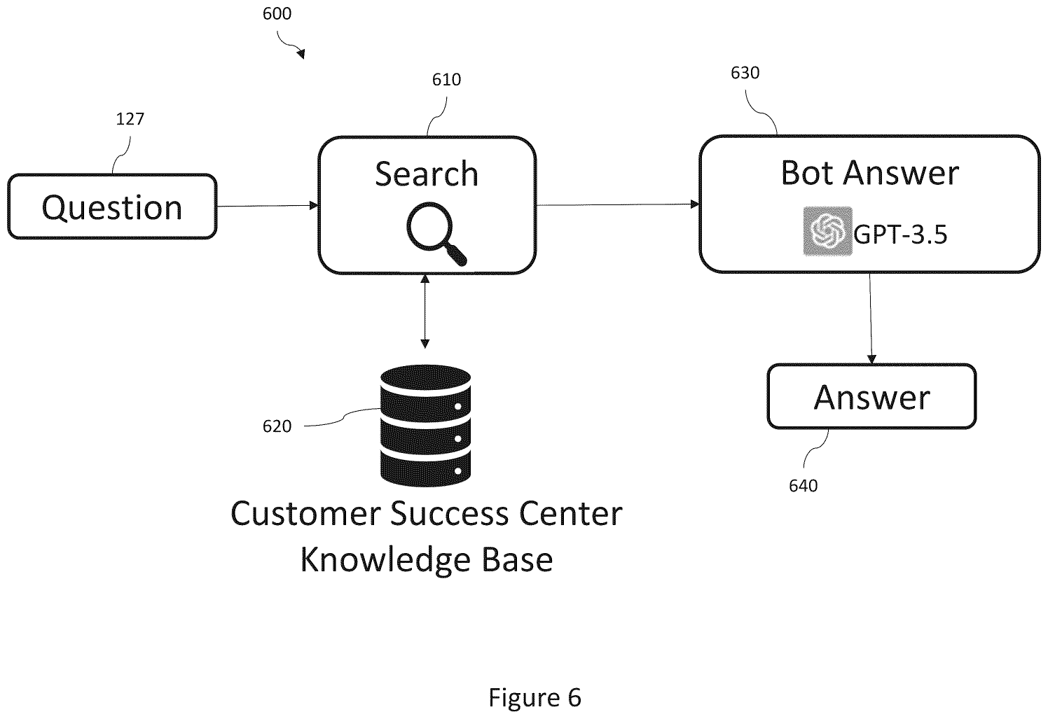

FIG. 6 is a schematic, diagrammatic representation, in block diagram form, of an example help bot agent 600, in accordance with at least one embodiment of the present disclosure. In the example shown in FIG. 6, the help bot agent 600 is a specific type of data agent 170 (see FIG. 3). When the help bot agent 600 receives a question 127, it initiates a search 610 of a knowledge base 620 (e.g., a customer support or customer success knowledge base). The search results 610 are then passed to an LLM 630 to be interpreted and summarized into an answer 640, which can then be passed upstream to the broker agent 130 (see FIG. 1). Depending on the implementation, the LLM 630 may be internal to the help bot agent, or may be an external, remote, or third-party LLM. The LLM 630 may be the same LLM as LLM 240 of FIG. 2, or may be a different LLM.

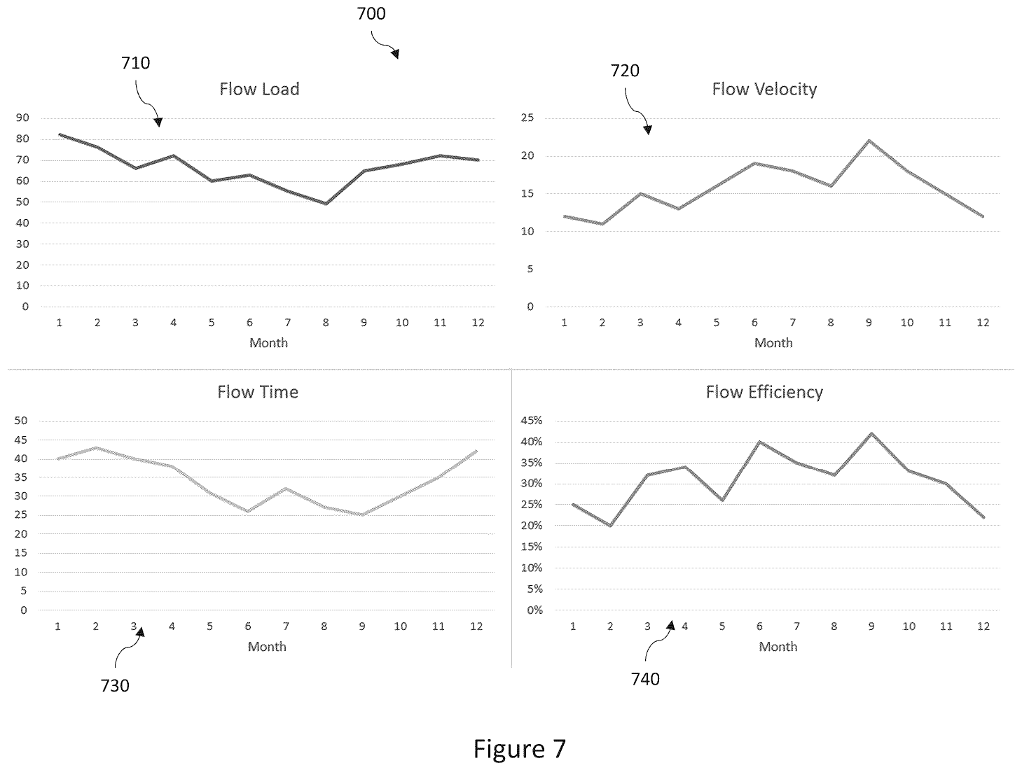

FIG. 7 is an example screen display 700 for a business intelligence application (e.g., application 110 of FIG. 1), in accordance with at least one embodiment of the present disclosure. The screen display includes time series graphs of flow load 710, flow velocity 720, flow time 730, and flow efficiency 740. This information, either in its graphical form or in a tabular (e.g., CSV) form, can be interpreted by a flow metric bot that interprets the data and outputs a natural language summary.

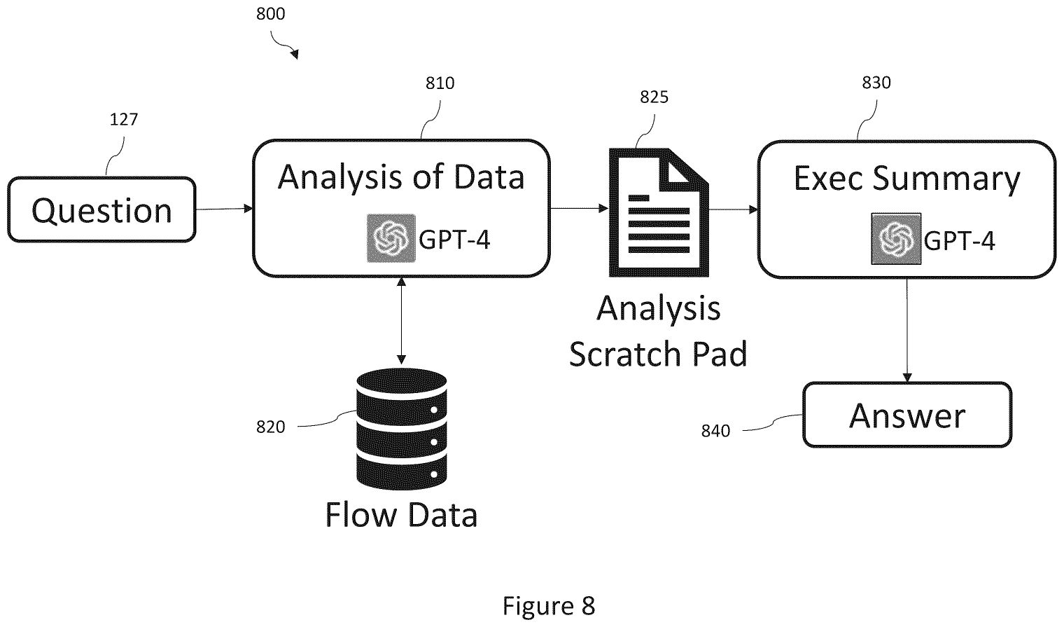

FIG. 8 is a schematic, diagrammatic representation, in block diagram form, of an example flow metric bot agent 800, in accordance with at least one embodiment of the present disclosure. In the example shown in FIG. 6, the flow metric bot agent 800 is a specific type of data agent 170 (see FIG. 3). When the flow metric bot agent 800 receives a question 127, the question 127 is passed to an LLM 810 that has access to the flow data 820, and that outputs a series of insights about the data onto a temporary file or scratchpad 825, which is then passed to the same or another LLM for summarization. This summary or answer 840 is then passed upstream to the broker agent 130 (see FIG. 1).

Depending on the implementation, the LLMs 810 and 830 may be internal to the help bot agent, or may be external, remote, or third-party LLMs. The LLMs 810 and 830 may be the same as one another and as LLM 240 of FIG. 2, or may be a different LLMs.

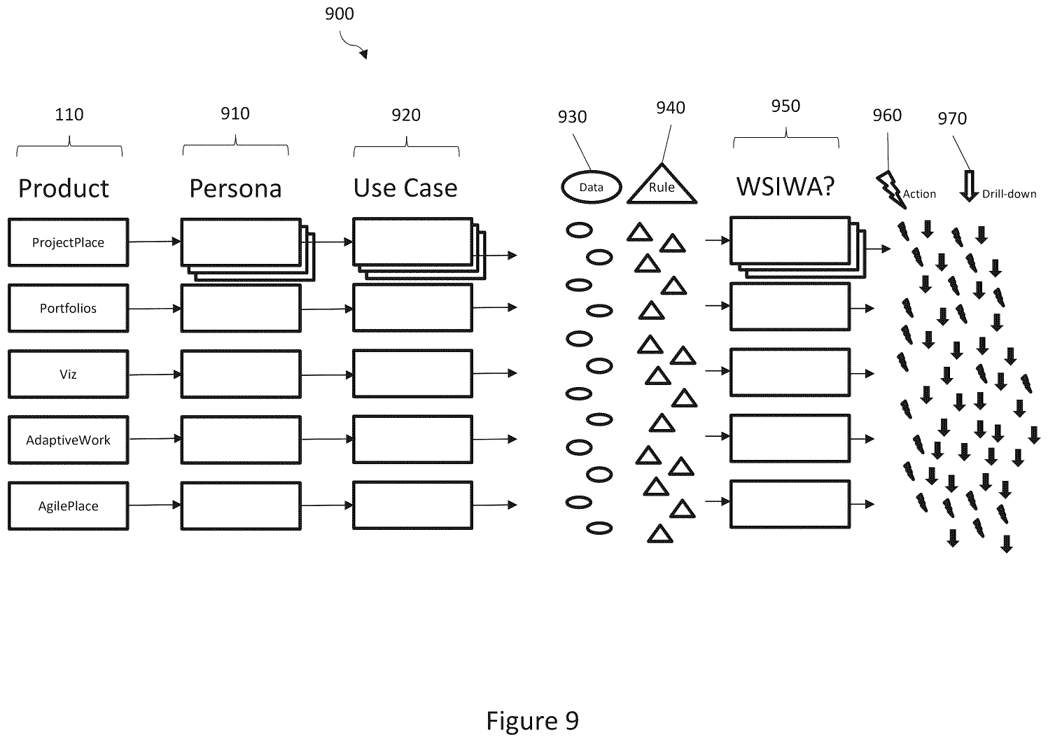

FIG. 9 is a schematic, diagrammatic representation, in block diagram form, of an example data flow 900 of an LLM copilot, in accordance with at least one embodiment of the present disclosure. The LLM copilot can be incorporated into a variety of different products or applications 110, and can generate prompts that apply a persona 910 (e.g., “You are a . . . ”) and a use case 920 (e.g., “Your job is to . . . ”) to the LLM. These prompts can then be enriched with data 930 and/or constrained with rules 940, such that a query 950 (e.g., “what should I worry about” or WSIWA) yields one or more actions 960 and/or one or more natural-language responses 970, with a level of detail specified by, for example, the user or the broker agent.

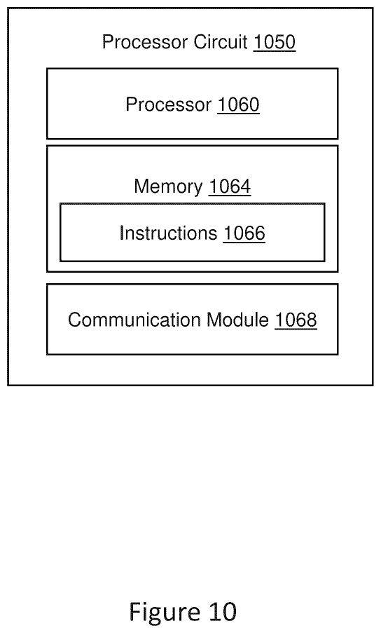

FIG. 10 is a schematic diagram of a processor circuit 1050, in accordance with at least one embodiment of the present disclosure. The processor circuit 1050 may be implemented in the system 100, or other devices or workstations (e.g., third-party workstations, network routers, etc.), or on a cloud processor or other remote processing unit, as necessary to implement the method. As shown, the processor circuit 1050 may include a processor 1060, a memory 1064, and a communication module 1068. These elements may be in direct or indirect communication with each other, for example via one or more buses.

The processor 1060 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1060 may also comprise another hardware device, a firmware device, or any combination thereof configured to perform the operations described herein. The processor 1060 may also be implemented as a combination of computing devices, e.g., a combination of a DSP and a microprocessor, a plurality of microprocessors, one or more microprocessors in conjunction with a DSP core, or any other such configuration.

The memory 1064 may include a cache memory (e.g., a cache memory of the processor 1060), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1064 includes a non-transitory computer-readable medium. The memory 1064 may store instructions 1066. The instructions 1066 may include instructions that, when executed by the processor 1060, cause the processor 1060 to perform the operations described herein. Instructions 1066 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1068 can include any electronic circuitry and/or logic circuitry to facilitate direct or indirect communication of data between the processor circuit 1050, and other processors or devices. In that regard, the communication module 1068 can be an input/output (I/O) device. In some instances, the communication module 1068 facilitates direct or indirect communication between various elements of the processor circuit 1050 and/or the system 100. The communication module 1068 may communicate within the processor circuit 1050 through numerous methods or protocols. Serial communication protocols may include but are not limited to United States Serial Protocol Interface (US SPI), Inter-Integrated Circuit (I2C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, sharing between the processor and central server, etc.) may be accomplished using any suitable wireless or wired communication technology, such as a cable interface such as a universal serial bus (USB), micro USB, Lightning, or Fire Wire® interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

As will be readily appreciated by those having ordinary skill in the art after becoming familiar with the teachings herein, the LLM copilot advantageously provides an intelligent front end for an LLM which both increases the capability of the LLM and constrains its outputs to be more useful. A number of variations are possible on the examples and embodiments described above. For example, the technology described herein may be applied to other types of software applications besides enterprise-level business intelligence and decision-making applications, including but not limited to small business software applications, resource planning, capacity management, product development, value stream management, agile planning, call center management, website analytics, and/or sales and operations planning applications. The LLM copilot may be interposed between the user and a chatbot of any sort, including a classical chatbot, expert system, LLM chatbot, or machine learning (ML) chatbot.

The logical operations making up the embodiments of the technology described herein are referred to variously as operations, steps, objects, elements, components, or modules. Furthermore, it should be understood that these may occur, or be performed or arranged, in any order, unless explicitly claimed otherwise or a specific order is inherently necessitated by the claim language.

All directional references e.g., upstream, downstream, upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the LLM copilot. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the LLM copilot as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system interposed between a user and a chatbot, the system comprising:
a processor and a computer readable medium operably coupled thereto, the computer readable medium comprising a plurality of instructions stored in association therewith that are accessible to, and executable by, the processor, to perform operations which comprise, in real time:
with a conversational interface, receiving a user input;
with a broker agent, based on the user input and a conversation history, passing the user input to at least one assistant agent, wherein the at least one assistant agent comprises an action agent or a data agent;
if the at least one assistant agent comprises an action agent:
determining an action consistent with the user input; and
executing the action; or
if the at least one assistant agent comprises a data agent:
fetching data from at least one database; and
based on the user input and the fetched data, generating a reply;
with the broker agent, in real time, based on the user input and the reply:
formulating a chatbot prompt;
passing the chatbot prompt to the chatbot;
receiving an answer from the chatbot; and
with the conversational interface, presenting the answer to the user.

2. The system of claim 1, further comprising the chatbot.

3. The system of claim 1, wherein the chatbot comprises a first large language model (LLM) chatbot or machine learning (ML) chatbot.

4. The system of claim 3, wherein the action agent, data agent, or broker agent comprises or communicates with a second LLM or ML chatbot.

5. The system of claim 4, wherein the second LLM or ML chatbot and the first LLM or ML chatbot are the same.

6. The system of claim 1,
wherein the action agent is selected from a plurality of action agents by the broker agent based on the user input; or
wherein the data agent is selected from a plurality of data agents by the broker agent based on the user input.

7. The system of claim 1, wherein the conversational interface is part of a business intelligence software application, wherein the at least one database comprises data related to a business, and wherein the user input is related to the data or the business.

8. The system of claim 7, wherein the data agent comprises a help bot, a flow metric bot, an objectives agent, a key results agent, or a roadmap agent.

9. The system of claim 7, wherein the at least one database comprises a customer success, customer service, flow data, objectives, key results, roadmap, project portfolio, work plan, or resource allocation database.

10. The system of claim 7, wherein the data comprises at least one of a document, application data, a knowledge graph, a tabular data frame, or a relational database.

11. The system of claim 1, wherein the at least one assistant agent comprises a plurality of data agents, and wherein formulating the chatbot prompt includes combining and summarizing replies from the plurality of data agents.

12. The system of claim 1, wherein the operations further comprise, with the broker agent:
summarizing the answer; and
with the conversational interface, presenting the summarized answer to the user.

13. A computer-implemented method for interposing between a user and a chatbot, the method comprising, in real time:
with a conversational interface, receiving a user input;
with a broker agent, based on the user input and a conversation history, passing the user input to at least one assistant agent, wherein the at least one assistant agent comprises an action agent or a data agent;
if the at least one assistant agent comprises an action agent:
determining an action consistent with the user input; and
executing the action; or
if the at least one assistant agent comprises a data agent:
fetching data from at least one database; and
based on the user input and the fetched data, generating a reply;
with the broker agent, in real time, based on the user input and the reply:
formulating a chatbot prompt;
passing the chatbot prompt to the chatbot;
receiving an answer from the chatbot; and
with the conversational interface, presenting the answer to the user.

14. The method of claim 13, wherein the chatbot comprises a first large language model (LLM) chatbot or machine learning (ML) chatbot.

15. The method of claim 14, wherein the action agent, data agent, or broker agent comprises or communicates with a second LLM or ML chatbot.

16. The method of claim 15, wherein the second LLM or ML chatbot and the first LLM or ML chatbot are the same.

17. The method of claim 13,
wherein the action agent is selected from a plurality of action agents by the broker agent based on the user input; or
wherein the data agent is selected from a plurality of data agents by the broker agent based on the user input.

18. The method of claim 13, wherein the at least one assistant agent comprises a plurality of data agents, and wherein formulating the chatbot prompt includes combining and summarizing replies from the plurality of data agents.

19. The method of claim 13, further comprising, with the broker agent:
summarizing the answer; and
with the conversational interface, presenting the summarized answer to the user.

20. A non-transitory computer-readable storage medium storing instructions, which when executed by at least one processor of a computer system, causes the computer system to carry out the method of claim 13

21. A computer system comprising:
one or more processors; and
a storage medium storing instructions, which when executed by at least one processor, cause the system to implement the method of claim 13.

22. The method of claim 13, wherein the conversational interface is part of a business intelligence software application, wherein the at least one database comprises data related to a business, and wherein the user input is related to the data or the business.

23. The method of claim 22, wherein the data agent comprises a help bot, a flow metric bot, an objectives agent, a key results agent, or a roadmap agent.

24. The method of claim 22, wherein the at least one database comprises a customer success, customer service, flow data, objectives, key results, roadmap, project portfolio, work plan, or resource allocation database.

25. The method of claim 22, wherein the data comprises at least one of a document, application data, a knowledge graph, a tabular data frame, or a relational database.
